(19) United States
(12) Patent Application Publication
(10) Pub. No.: US 2004/0240923 A1
(43) Pub. Date: Dec. 2, 2004

(54) Thermal printer

(76) Inventors: Etienne Warrin, Chalonnes sur Loire (FR); Eric Fontes, Trelaze (FR)

Correspondence Address: John J Gresens, MERCHANT & GOULD, P.O. Box 2903, Minneapolis, MN, 55402-0903, US

(21) Appl. No.: 09/856,003

(22) Filed: May 15, 2001

(30) Foreign Application Priority Data
May 15, 2000 (WO) PCT/FR00/06174

(51) Int. Cl. B41J 2/315

(52) U.S. Cl. 400/120.01

(57) ABSTRACT

The invention relates to thermal printers for printing on flat objects such as plastic or cardboard cards, for example loyalty cards or even chip cards, magnetic cards or any other similar media.

According to the invention, the printer comprises a motor-driven roller (14) mobile with respect to said printing head (13), along a substantially vertical axis, so that the gap between said roller (14) and said printing head (13) is able to vary depending on the thickness of said object (30) to be printed.

The invention relates to the field of thermal printers, whether by direct thermal printing or by thermal transfer. More particularly, the invention relates to thermal printers for printing on flat objects such as plastic or cardboard cards, for example loyalty cards or even chip cards, magnetic cards or any other similar media.

Thermal printers may operate according to two different principles: direct thermal printing or thermal transfer. In machines operating according to the direct thermal printing principle, the printing head is directly put into contact with the media to be printed. The latter is specially coated in such a way that the applied heat causes a change in structure at its surface, generally expressed by a change in color. According to the second principle, by so-called thermal transfer, an ink-bearing film is inserted between the printing head and the object to be printed, the applied heat causing the transfer of the ink of the film onto the object.

However in both cases, the printing head includes a line of local heating points, wherein an electronic control selects the points to be printed.

In these printers, the printing head may be vertical, laid flat or with a so-called “corner edge” (technology according to which the line of heating components is located in an angle of the printing head, the latter being then inclined with respect to the vertical).

These machines are currently used for customizing cards, such as chip cards, magnetic cards or even loyalty cards, identity badges, access cards, subscription cards or any other similar media.

Notably for loyalty cards, techniques have appeared recently, which enable the printed data on a card to be deleted and new messages to be written again. It is thus possible to have a same loyalty card visibly bearing a point credit which changes, on a same subscription card, the characteristics specific to each customer or user of the card, promotional messages or any other data likely to be changed at each passage of the customer.

Presently, the thickness of the cards to be printed varies between 0.2 mm and 1.5 mm. A user of a card-printing machine, for example a shopkeeper, may thus have several batches of cards at his disposal, the thickness of the cards varying from one batch to the other. In parallel, a user may choose a certain card thickness, while another one will opt for a different thickness.

It is thus essential that the provided printers be able to tolerate different card thicknesses and that, from an economical point of view, the printer manufacturer should not be forced to provide as many printer designs as there are card thicknesses.

In the prior state of the art, several solutions are provided in order to make at least one unit of the printer mobile in the direction of the card to be printed.

The patent document EP-O 55/405 describes a printer including a printer head mounted on a mobile carriage which allows it to be lifted or lowered perpendicularly to the surface of the card. The carriage is mounted on an endless screw driven into rotation by a motor. The printing head is further pivotally mounted so as to be properly applied against the card over the whole of its length.

Another type of known solution consists of using a pressure roller system, which will bend the card in the direction of the printing head, wherein motor-driven rollers positioned on both side of the printing head provide the advance of the card under the printing head.

Moreover, certain machines integrate mobile printing heads in vertical translation, by means of a guiding and motorization system of the printing head.

These solutions implement complex mechanical, electrical and electronic units, which notably generate manufacturing constraints that are passed onto the cost of the machines.

Further, these prior techniques generate cumbersome units, frequently incompatible with the users' expectation.

The object of the invention is notably to overcome these drawbacks of the prior art.

More specifically, the object of the invention is notably to provide a printer able to efficiently carry out printing jobs on flat objects over different thicknesses.

In other words, the object of the invention is to provide a same machine to users who have to print objects, for example cards, which do not have the same thickness, without it being necessary to perform adjustments on the machine.

Another object of the invention is to provide a printer that tolerates slight thickness variations on a same object to be printed.

The object of the invention is also to provide such a printer which implements not very complicated mechanical units and for which maintenance may be provided in a simple way.

Still another object of the invention is to provide a printer that is less bulky as compared with prior art machines.

The object of the invention is also to provide such a printer that is not very expensive to manufacture and to assemble.

These objects as well as others which will appear subsequently, are achieved by means of a thermal printer of the type comprising at least a printing head and a motor-driven roller able to drive a flat object to be printed under said printing head. According to the invention, the printer comprises a motor-driven roller mobile with respect to said printing head, along a substantially vertical axis, such that the gap between said motor-driven roller and said printing head is able to vary depending on the thickness of said object to be printed.

The roller thus provides a double function: it drives the card under the printing head so that the head transfers inscriptions thereon, line by line, and it changes its position depending on the thickness of the card.

According to another particularly advantageous feature, said printing head is fixed, at least in vertical translation. No setting or particular adjustment is thus necessary. Very accurate motorization devices coupled with different distance or limit sensors, generally very expensive, are thus avoided.

According to an advantageous feature, the axis of rotation of said motor-driven roller is substantially located at the vertical of the line of heating components borne by said printing head. In this way driving units for the card are thus avoided on both sides of the printing head. In this configuration, a single motor-driven roller is sufficient.

According to a preferred feature, the bearings supporting said motor-driven roller are coupled with elastic spring means. Through this simple and effective technique, the motor-driven roller may move away from the printing head under the thrust of the object to be printed, whereby the elastic spring means exert pressure under the object in order to keep it against the printing head.

Advantageously, said bearings are securely fixed to a feed plate. This plate may prove to be useful notably for facilitating the guiding and feeding of the object between the motor-driven roller and the printing head.

According to another feature, the printer comprises means for providing a predetermined gap between said roller and said printing head. This gap under no load promotes the pinching of the card between the motor-driven roller driven into rotation and the printing head. In the case of thermal transfer machines, this gap also prevents the ink-bearing film from being driven under no load.

According to an advantageous feature, said means providing a predetermined gap comprise at least a stop securely fixed to said bearings or to the axis of said motor-driven roller. The bearings, suitably dimensioned, may in this case fulfil a double function consisting of supporting the axis of the motor-driven roller on the one hand, and of lying against the support of the printing head on the other hand, in the absence of an object being printed.

Other features and advantages of the invention will be more clearly apparent upon reading the following description of two preferred embodiments of the invention, given as illustrative and non-limiting examples and the appended drawings wherein:

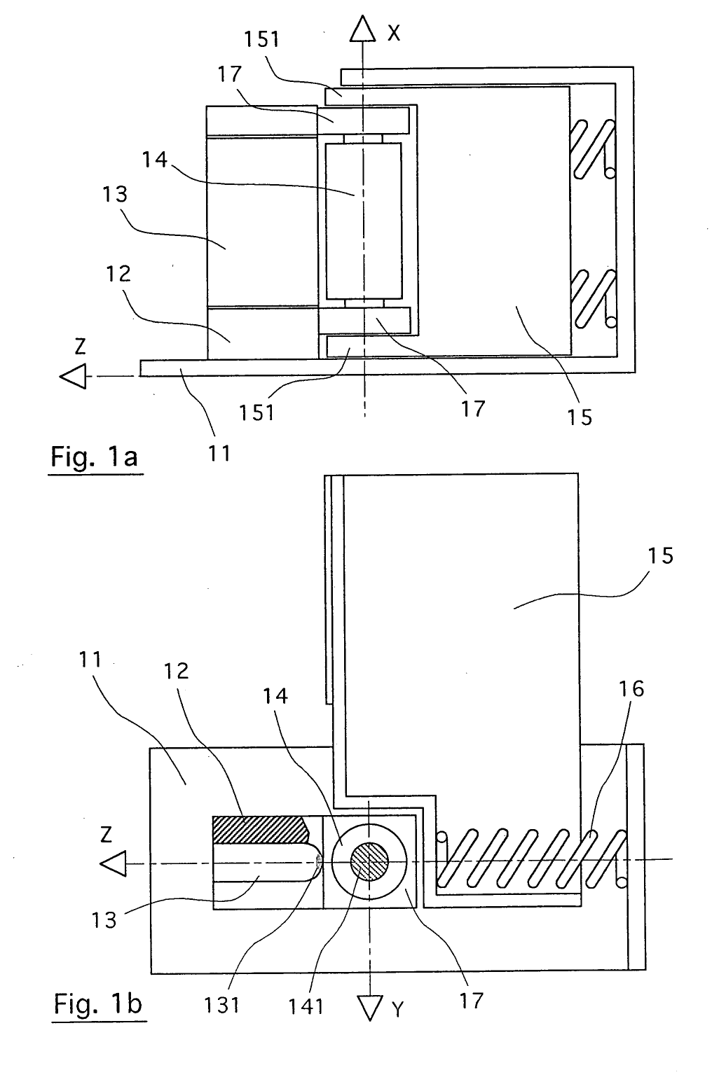

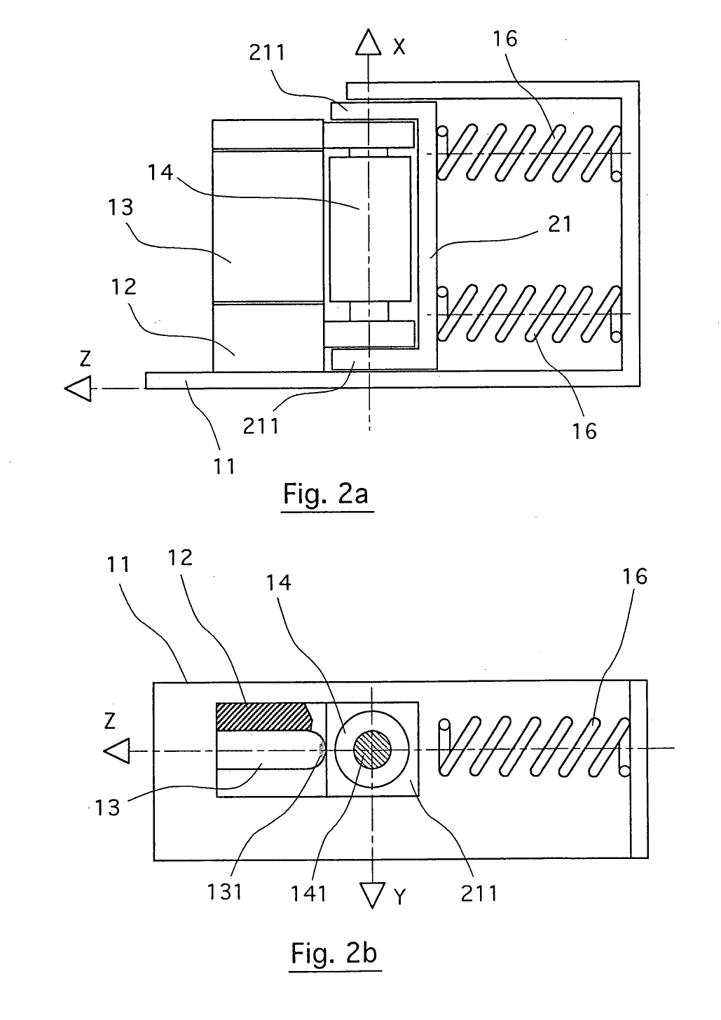

FIGS. 2a and 1b illustrate a printer according to a first embodiment of the invention;

FIGS. 2a and 2b illustrate a printer according to a second embodiment of the invention;

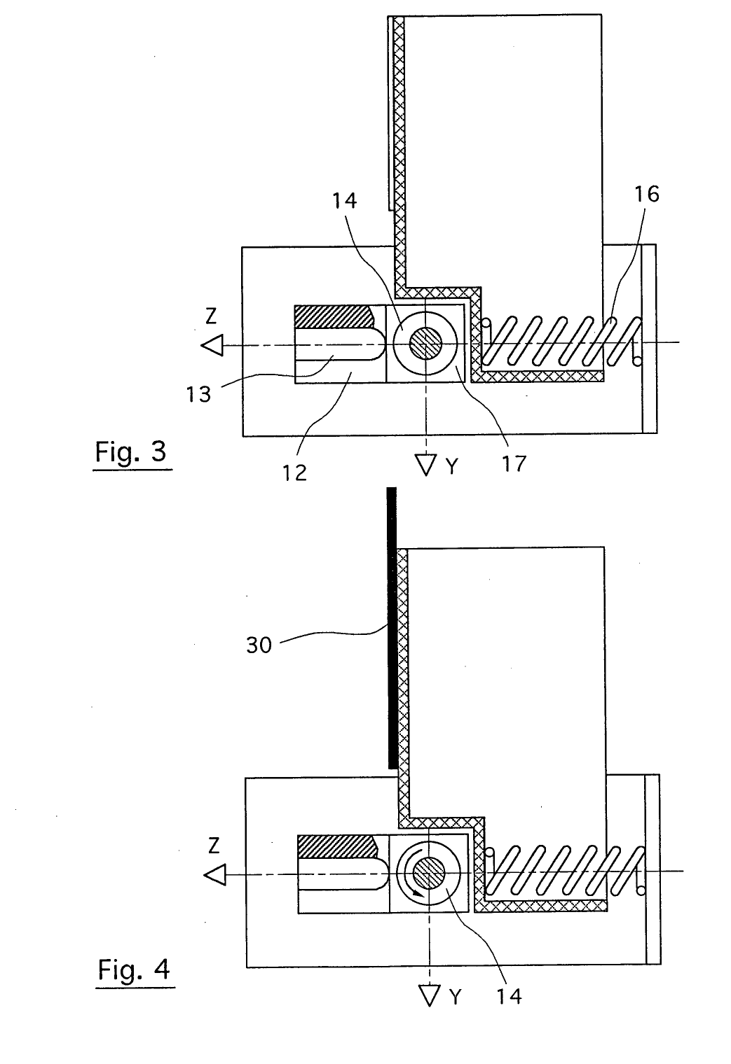

FIGS. 3-8 illustrate different steps of the operation of the printer according to the invention.

The general principle of the invention is thus based on a simple and effective technique, consisting of making a motor-driven roller mobile for which the active generator is substantially at the vertical of the line of the heating points borne by the printing head.

In FIGS. 1a and 1b, a first embodiment of a printer according to the invention is illustrated in a front and side view respectively in the direction of the path of an object to be printed.

This printer includes a frame or chassis 11, on which is securely fixed a support 12, on which the printing head 13 is added and fixed. The printing head bears a line 131 of elementary electronically controlled heating points.

In the example illustrated in the figures, as well as in the following figures, the printing head is vertical. However, a so-called “flat” or “corner edge” printing head may be preferred without departing from the scope of the invention.

The axis 141 of the motor-driven roller 14 is supported at each of its ends by bearings 151 provided for this purpose in a feed plate 15.

The feed plate 15 forms a support facilitating the guiding of the object, in a substantially horizontal way, towards the motor-driven roller 14 and the printing head 13. The operator has thus just to push the object lying on the feed plate 15.

The bearings and the feed plate are placed so that the active generator of the motor-driven roller (i.e., the generator able to be in contact with an object to be printed in order to force it to move along the Y axis) and the line 131 of elementary heating points are substantially parallel to the X axis and perpendicular to the Z axis.

The thus positioned motor-driven roller 14 is sufficient by itself to force an object to move so that the object passes under the printing head 13 over its entire length.

The feed plate 15 is guided in vertical translation on chassis 11 by means known per se such as slides or any other similar means.

The elastic spring means 16, such as springs with helical non-jointive spires are inserted between the feed plate 15 and chassis 11, wherein the spring's axis substantially coincides with the Z axis according to the view in FIG. 1b.

These elastic spring means are selected in order to provide travel of the plate 15 on the chassis 11, at least equal to the range of thicknesses of objects liable to be printed.

At least one stop and preferably two stops 17 are mounted on axis 141, on both sides of the motor-driven roller 14. In the absence of an object to be printed, these stops 17 lie against support 12 of the printing head, maintaining a minimum gap between the active generator of the motor-driven roller 14 and the line of the elementary heating points, of the order of 0.15 mm.

This gap is selected so as to be slightly less than the smallest thickness of the objects liable to be printed. It provides the necessary pinching upon the driving of the object between the motor-driven roller 14 and the printing head 13. Without this gap, depending on the thickness of the object, the latter may come and abut against roller 14 and the printing head 13, and require the operator to somewhat force its insertion.

The motor means (not shown) providing the setting of the motor-driven roller 14 into rotation are securely fixed to the feed plate 15.

By the means that have just been described, the printer of the invention accepts in a simple and effective way, flat objects such as loyalty or other cards, of different thicknesses.

Indeed, by the joint action of the thrust of the operator and of the motor of the roller 14, the object is fed in between the roller 14 and the printing head while the plate 15 is moved vertically as required depending on the thickness of the object. The spring means exert pressure from the object against the printing head 13, and bring the plate back to its waiting position at the end of the printing, the stops 17 lying against support 12 of the printing head.

According to a second embodiment aimed at reducing the bulk of the machine, such as illustrated in FIGS. 2a and 2b, the motor-driven roller 14 is supported by a cradle 21, the uprights of which 211 have bearings receiving the axis 141.

The uprights 211 comprise means in order to be guided in vertical translation, along the slides or any other similar means provided in chassis 11.

The uprights are dimensioned in order to lie, in the absence of objects to be printed, against the support 12 of the printing head and to maintain the gap between the active generator of the motor-driven roller 14 and the line 13 of the elementary heating points, as mentioned earlier.

Springs 16 are inserted between the cradle 21 and chassis 11, wherein the spring's axes substantially coincide with the Z axis according to the view in FIG. 2b.

In order to reduce the bulk in height, an adaptation of the cradle may also be contemplated so that the springs 16 extend above the latter, whereby springs 16 are then drawn rather than compressed.

The feed plate 15 of the first embodiment is removed from the second embodiment, so that the goal of reducing bulk may be achieved. The motor means (not shown), providing the setting of the motor-driven roller 14 into rotation, are here securely fixed to the cradle 21.

In the absence of guiding means as formed by the plate 15 in the first embodiment, it is the operator who should insert the object in an appropriate way, whereby a slit may be provided in the chassis in order to assist him in his gesture.

The different operating steps for the printer according to the invention will now be detailed with the help of FIGS. 3-8.

FIG. 3 shows the printer in the waiting position. Stops 17 lie against the support 12 of the printing head 13, under the action of the slightly compressed springs 16. The motor-driven roller 14 is stopped.

In FIG. 4, an object to be printed 30 is illustrated, such as a plasticized card for example, placed on the feed plate 15. Motor means are triggered in order to drive the roller 14 into rotation, either by the operator having a control in order to do this or by a signal issued from a device detecting the object 30 on the plate 15.

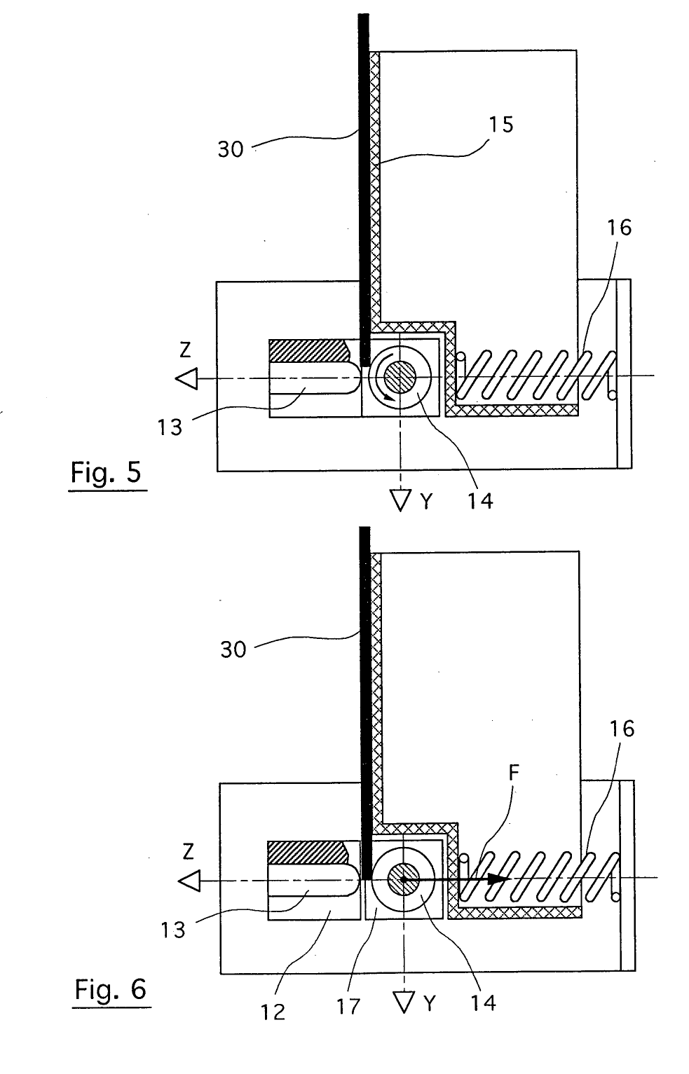

As illustrated in FIG. 5, the object 30 is pushed onto the surface of the plate 15 until it comes into contact with the motor-driven roller 14 and the printing head 13.

Under the joint action of the thrust of the operator on object 30 and the rotation of the motor-driven roller 14, the object 30 is fed in between the roller 14 and the printing head, whereby roller 14 and therefore the plate which supports it, is displaced along the arrow F (indicted in FIG. 6) as required depending on the thickness of the object 30. The stops 17 therefore move away from the support 12. Springs 16 are thus a little more compressed and exert a thrust under the plate 15, in such a way that the object is maintained pressed against the printing head 13.

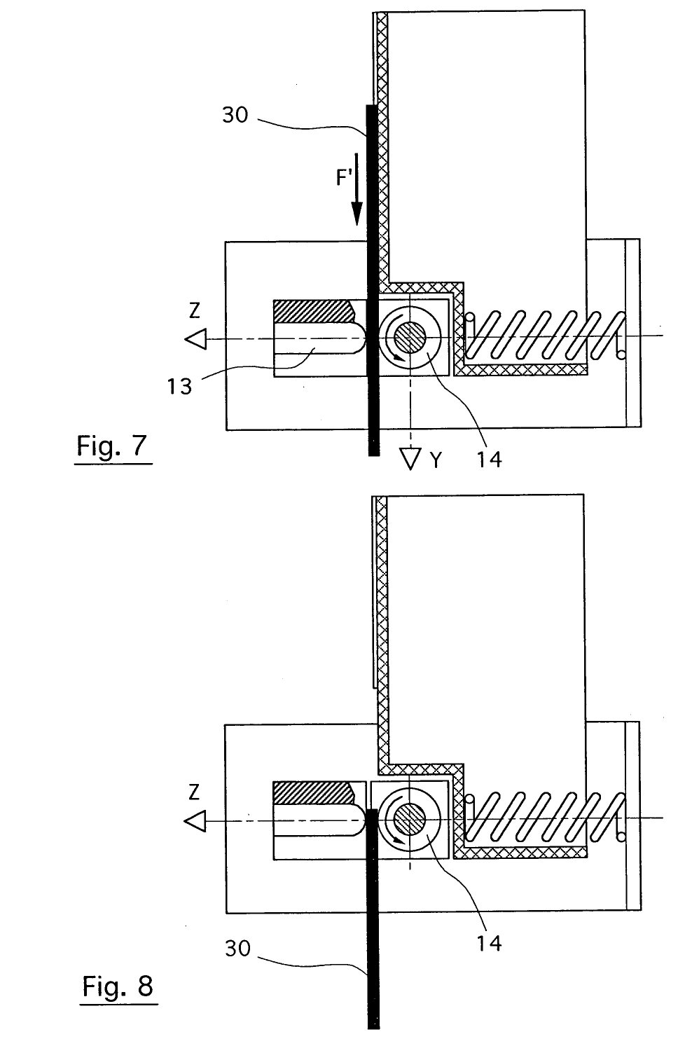

As shown in FIG. 7, the object 30 is then moved along the arrow F′ under the printing head 13 under the action of the motor-driven roller 14, wherein the rotation of the roller is of the stepped type so that printing is performed line by line.

In FIG. 8, the object 30 is in a position which precedes an end of a printing cycle. The object is then ejected from the printing area under the action of roller 14.

Springs 16 then bring back the printer to the waiting position (FIG. 3), whereby stops 7 lie against support 12 once again.

Such a printer may therefore successively accept objects of different thicknesses without any particular intervention from the user.

The invention notably finds a particularly interesting application in loyalty cards for which the thicknesses may vary, according to the material and the required stiffness, between 0.2 and 1.5 mm.

Accordingly the invention provides a solution fulfilling a novel function with simple mechanisms which in addition to the performances of the machine enable the manufacturing costs of such printers to be reduced as compared with the prior state of the art.

1. A thermal printer comprising at least a printing head (13) and a motor-driven roller (14) able to drive a flat object (30) to be printed under said printing head (13), characterized in that it comprises a motor-driven roller (14) mobile with respect to said printing head (13), along a substantially vertical axis, so that the gap between said motor-driven roller (14) and said printing head (13) is able to vary depending on the thickness of said object (30) to be printed.

2. A printer according to claim 1, characterized in that said printing head (13) is fixed, at least in vertical translation.

3. A printer according to any of claims 1 and 2, characterized in that the axis (141) of rotation of said motor roller (14) is substantially located at the vertical of the line of heating components (131) borne by said printing head (13).

4. A printer according to any of claims 1 to 3, characterized in that the bearings (151, 211) supporting said motor-driven roller (14) are coupled with elastic spring means (16).

5. A printer according to any of claims 1 to 4, characterized in that said bearings (151) are securely fixed to a feed plate (15).

6. A printer according to any of claims 1 to 5, characterized in that it comprises means (17) for providing a predetermined gap between said roller (14) and said printing head (13).

7. A printer according to claim 6, characterized in that said means (17) providing a predetermined gap comprise at least a stop securely fixed to said bearings (151, 211) or to the axis (141) of said motor-driven roller (14).
